(19) United States
(12) Patent Application Publication
(10) Pub. No.: US 2008/0317700 A1
(43) Pub. Date: Dec. 25, 2008

(54) Synthesis and biological activity of photopolymerizable derivatives of glyphosate

(75) Inventors: Douglas C. Neckers, Perrysburg, OH (US); Aneta Bogdanova, W. Caldwell, NJ (US); Andrei V. Fedorov, San Mateo, CA (US)

Correspondence Address: ROGER A. GILCREST, 250 WEST STREET, COLUMBUS, OH, 43216-7513, US

(73) Assignee: Bowling Green State University, Bowling Green, OH (US)

(21) Appl. No.: 12/004,595

(22) Filed: Dec. 21, 2007

Related U.S. Application Data
(60) Provisional application No. 60/876,713, filed on Dec. 21, 2006.

(51) Int. Cl. A01N 57/20; C07F 9/38; C08F 130/02; A01P 13/00; C09D 143/02; C08F 230/02

(52) U.S. Cl. 424/78.09; 562/17; 526/278; 562/15; 504/206

(57) ABSTRACT

The present invention holds forth improvements in the field of herbicide synthesis, their application, and methods of plant and weed control and antifouling. The present invention includes the synthesis of new acrylate and methacrylate derivatives of a glyphosate. Two isomers resulting from a hindered rotation around the amide CN bond are observed for both acrylic and methacrylic analogs and barriers for internal rotation are obtained. Biological activity tests indicate that functionalized glyphosates possess herbicidal activity similar to the parent compound.

### RELATED APPLICATION DATA

This application claims the priority benefit of U.S. Provisional Application Ser. No. 60/876,713, filed Dec. 21, 2006, which is hereby incorporated in its entirety herein by reference.

### STATEMENT OF GOVERNMENT INTEREST

This invention was made with funding from the U.S. Government through the Office of Naval Research (Grant No. N00014-04-1-0406). The U.S. Government may have certain rights in this invention.

### TECHNICAL FIELD OF THE INVENTION

The present invention is in the field of herbicides and related herbicidal and antifouling compositions, articles and methods.

### BACKGROUND AND SUMMARY OF THE INVENTION

The present invention holds forth improvements in the field of herbicide synthesis, their application, and methods of plant and weed control and antifouling.

The present invention includes the synthesis of new acrylate and methacrylate derivatives of a glyphosate. Two isomers resulting from a hindered rotation around the amide CN bond are observed for both acrylic and methacrylic analogs and barriers for internal rotation are obtained. Biological activity tests indicate that functionalized glyphosates possess herbicidal activity similar to the parent compound. Only the acrylated glyphosate derivatives undergo photopolymerization. The resulting photopolymer of acrylated glyphosate retains the biological activity. The methacrylated glyphosates are unreactive. Differential reactivity is explained by the different conformational preferences of the functionalized glyphosates. The experimental findings are supported by the results of DFT geometry optimizations.

Photopolymerization holds two basic advantages over other routes of converting a liquid to a solid. The initiating stimulus (light) can be turned on or off so, for the most part, whether or not a polymerization occurs can be controlled. Light can also be imaged. Where light impinges on a to-be-polymerized monomer or oligomer mixture, polymerization occurs. Where it does not, there is no reaction. Nevertheless and somewhat surprisingly, only a limited number of photopolymerization processes have impacted the life sciences. Though photopolymerized gels for electrophoresis have been known since the 1950's, and various monomer/oligomer formulations are used in dental applications, photopolymers that are used in other applications to encapsulate or coat have not been used to encapsulate biologically active compounds or coat surfaces with biological attractants/repellants. There are no known examples of which we are aware in which one has prepared an imaged surface with a bioattractant or repellant in the context of the biophotoresist—an effective biologically active compound imaged on a surface at the level of pixel resolution. The present invention provides an opportunity to prepare imaged biophotoresist by allowing one to create patterned deposits of precursor materials of the present invention which then may be photopolymerized.

N-(Phosphonomethyl)glycine [Glyphosate] 1 is a broad action, non-selective systematic

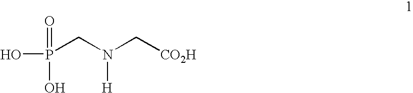

herbicide that kills many annual or perennial grasses and broadleaf weeds, as well as many species of trees and brush. The basis of the herbicidal activity of glyphosate is its quick penetration into a plant's leaves where it efficiently disrupts the synthesis of essential amino acids needed for protein generation. Glyphosate is generally used commercially in the form of its isopropylammonium salt, was marketed and originally patented by Monsanto and is known by the trade name Roundupe®.^{1,2}

Despite the broad use of glyphosate in agriculture, little is known about its chemical reactivity and only a small number of glyphosate derivatives have been reported.³ Glyphosate is tri-functional and each individual functionality is difficult to convert in the absence of reactions of the others which partially explains its lack of study. As a part of the present invention to provide bioreactive photopolymers, one may prepare acrylic and methacrylic acid derivatives of glyphosate, convert them to polymers or otherwise include them in polymers, and determine their biological activity.

Biofouling, the undesired attachment of microorganisms, plants and invertebrates to an underwater surface, represents a major problem for seagoing vessels.^{16, 17} A thick layer of marine organisms that rapidly forms on a ship compromises the speed and maneuverability of the vessel which, in turn, increases fuel consumption and results in elevated release of harmful emissions. Biofouling can also enhance the corrosion of metal by seawater and it can promote the undesired transport of marine organisms from one ecosystem to another.

The prevention of biofouling has been a subject of intense research for decades.¹⁷ Several sequential steps are proposed for marine fouling.^{18, 19} Initially, a surface of any submerged object can serve as a substrate for a thin film of adsorbed organic compounds. Bacteria (including cyanobacteria) can colonize the surface within hours followed by single cell diatoms that secrete sticky extracellular polymeric substances leading to the formation of a microbial biofilm. The presence of adhesive residues promotes further attachment of marine microorganisms including larger marine invertebrates (i.e., barnacles, sponges, etc.) that attach and grow together with macroalgae such as Enteromorpha.

Modern antifouling coating compositions fall into three main categories: contact leaching biocidal coatings,²⁰ self-polishing biocidal coatings,²¹ and biocide-free foul release coatings.²² The latter are the most promising. However, even the latest foul-release formulations lack efficiency, are expensive, and work only when vessels are in motion.²³ A Convention adopted in 2001 by the International Maritime Organization will prohibit, upon ratification by member states, all use of toxic tin-based paint formulations by Jan. 1, 2008.²⁴ A similar fate may await the use of Cu-containing compositions. The disadvantage of the leading biocidal coatings is their short service lifetime. The biocide is rapidly depleted because it is generally mechanically blended into the polymer coating matrix.

The present invention includes compositions of matter and methods of their synthesis, the compositions including a new class of photopolymerizable derivatives of glyphosate with herbicidal activity. The synthetic route to acrylic and methacrylic acid derivatives of the present invention is given in Scheme 1:

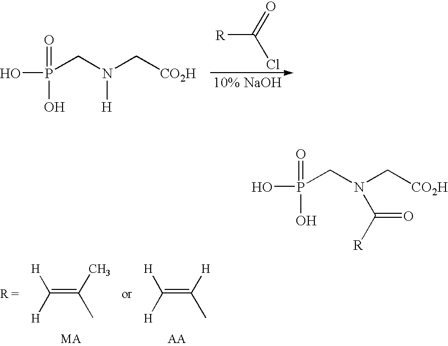

The present invention also includes methods of application and use of photopolymerizable polyolacrylate coating formulations, such as for the antifouling purposes, containing a new type of a biocide, a glyphosate derivative containing an acrylic functionality (1).¹⁰

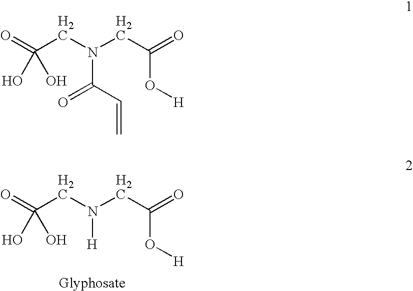

The parent glyphosate (2), commercially known as Roundup®, is a well-known non-selective systematic phosphonate herbicide. It is an effective inhibitor of the shikimic acid pathway in microorganisms and plants. The target of glyphosate action is 5-enolpyruvylshikimate 3-phosphate (EPSP) synthase, an enzyme responsible for the synthesis of essential aromatic amino acids.^{11,12} Because EPSP synthase does not exist in mammals and other marine animals, compounds containing the glyphosate functionality could be attractive biocides for antifouling applications. Another important feature is ready the degradation of a glyphosate by some microorganisms thereby preventing its accumulation in the environment.¹³

In general terms, the invention includes a composition comprising an acrylamide derivative of glyphosate, as well as a composition comprising a methacrylamide derivative of glyphosate.

Thus, the present invention includes a molecule having a formula selected from the group consisting of:

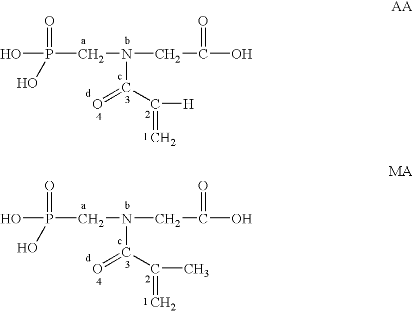

Also included in the present invention are polymeric compositions comprising monomeric units derived from an acrylamide derivative of glyphosate. The present invention therefore includes a homopolymer or copolymer having a monomeric unit derived from a compound having the formula:

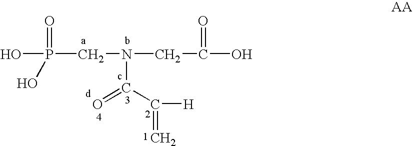

The polymers may be homopolymers, copolymers or block copolymers. Optionally, they may include a co-polymer formed from monomeric units of at least one other acrylic resin or a resin that contains double carbon-carbon bonds capable of polymerization. Examples of other acrylic resin include those that may be composed of monomers known and used in the art (e.g., as described in U.S. Pat. Nos. 5,539,070 by Zharov: column 7, line 39 through column 10, line 43; 5,994,484 by Pocius: column 15 line 30 through column 19, line 60; and 6,867,271 by Maandi: column 5 line 20 through column 8 line 20), all of which are hereby incorporated herein by reference.

The invention further includes a method of making an acrylamide derivative of glyphosate comprising the step of reacting glyphosate with at least one acryloyl halide for sufficient time to allow for the formation of an acrylamide derivative of glyphosate. Likewise, the invention also includes a method of making a methacrylamide derivative of glyphosate comprising the step of reacting glyphosate with at least one methacryloyl halide for sufficient time to allow for the formation of an methacrylamide derivative of glyphosate.

Also part of the present invention is a method of coating a substrate with a polymeric coating, said method comprising the steps: (a) placing on said substrate a coating precursor comprising an acrylamide derivative of glyphosate; and

(b) polymerizing said acrylamide derivative of glyphosate so as to form a polymeric coating upon said substrate. The polymerization may be thermally activated or light activated, although photopolymerization is preferred.

The present invention also includes a method for using the biological activity of the acrylated derivative of a glyphosate.¹⁰ Because this glyphosate derivative acts as a herbicide, its presence in a coating may impede biofilm formation by preventing attachment of photosynthetic cyanobacteria and diatoms. This, in turn, is expected may prevent the attachment of larger invertebrates. In addition, an acrylic functionality permits chemical incorporation of the biocide into a coating ensuring better control of release rates. This, in turn, is expected to prolong the service lifetime of the coating.

Accordingly, the present invention includes a method of removing or reducing plant life in terrestrial or aquatic environments. The present invention includes a method of removing or reducing plant life in a terrestrial environment comprising placing in contact with said plant life a polymeric coating of one or more polymers of the present invention. Likewise, the present invention includes a method of removing or reducing plant life in an aquatic environment comprising placing in said aquatic environment one or more polymers of the present invention. The present invention also includes a method of preventing biofouling of an article in an aquatic environment, such as a conduit, a ship or marine machinery, comprising placing upon said article a polymeric coating of one or more polymers of the present invention.

### BRIEF DESCRIPTION OF THE DRAWINGS

FIG. 1—¹H NMR spectrum of N-methacryloyl-N-(phosphonomethyl)glycine (MA).

FIG. 2—Temperature-dependent ¹H NMR spectra of MA.

FIG. 3—Temperature-dependent ¹H NMR spectra of AA.

FIG. 4—Polymerization of AA in the presence of different photoinitiators.

FIG. 5—Results of C(P)—N—C═C Amide bond rotational analysis for both AA and MA.

FIG. 6—Results of C═C—C═O acryloyl bond rotational analysis for both AA and MA.

FIG. 7—Synechococcus 7002 growth inhibition by the glyphosate and its acrylated derivative.

FIG. 8—Results of copolymerization experiments.

FIG. 9—NMR spectra of 459S2+0.3 M of AA (lower) and 459S2+0.3 M of glyphosate (upper) in D₂O after 18 days of shaking. Inset: normalized amount of active component released from the coating as a function of testing time.

FIG. 10—Typical UV-vis spectrum obtained after the chlorophyll extraction. Inset: differences in the amount of chl extracted for various samples.

### DETAILED DESCRIPTION OF THE PREFERRED EMBODIMENTS

In accordance with the foregoing summary, the following represents a description of the preferred embodiments of the present invention, which are presently considered to be the best mode.

The preferred embodiment involves the following materials and methods:

Materials. N-(phosphonomethyl)glycine was obtained commercially from Aldrich and used as received. Acryloyl chloride (Aldrich) and methacryloyl chloride (Alfa Aesar) were distilled prior to use. Darocur® 1173 and Irgacure® 651 were obtained from Ciba Specialty Chemicals, Inc. The water-soluble diazo initiators, VA-086, VA-085, and VA-057, were obtained from Wako Pure Chemical Industries, Ltd.

General procedures. Nuclear magnetic resonance (NMR) spectra were recorded on either a Varian Unity+400 MHz or a Bruker Advance 300 MHz spectrometers. The NMR experiments at elevated temperatures were carried out on a Varian Unity+400 MHz spectrometer. All NMR spectra were recorded in deuterium oxide (D₂O), chemical shifts are reported in ppm and referenced to 3-(trimethylsilyl) propionic acid-d₄, sodium salt (TSP). FTIR spectra were recorded on a ThermoNicolet IR200 spectrometer. High-resolution mass spectral analyses were performed by the mass spectrometry laboratory, University of Illinois at Urbana-Champaign, Ill.

Polymerization Procedures. Polymerizations were carried out by irradiation of 17% solutions of glyphosate derivatives in D₂O in the presence of 1.5% wt. initiator using a RMR-600 Rayonet photochemical reactor equipped with seven lamps (λₑₓ=350 nm). The double bond conversion of monomer was followed with ¹H NMR using the TSP signal as the internal standard.

Molecular weight of the resulting photopolymer was determined using size exclusion chromatography (SEC). Waters HPLC system (two 515 pumps and 996 diode array detector) was equipped with Superdex™ 200 column from Amersham Biosciences with 1-100 kDa separation range. The polymer sample was dissolved in phosphate buffer with pH=7 (50 mM KH₂PO₄ and 100 mM KCl) and eluted through the column at 1 ml/min with detection at 210 nm. The molecular mass of the resulting polymer was determined using calibration line obtained from analyzing solutions of dextranes having different molecular masses.

Synthesis of N-Methacryloyl-N-(phosphonomethyl)glycine (MA). The synthesis of MA was carried out according to the method reported by Gough⁴ with several modifications. N-(phosphonomethyl)glycine (0.169 g, 1 mmol) was dissolved in 2.4 mL 10% sodium hydroxide solution. Then, to a vigorously stirred solution, methacryloyl chloride (0.146 mL, 1.5 mmol) was added under argon dropwise. After continuous stirring for four hours at room temperature, the reaction mixture was acidified with hydrochloric acid to pH=0 or below, and concentrated under vacuum to precipitate the NaCl, which was removed by filtration. The pH of the filtrate was then adjusted to 1-2 by adding sodium hydroxide solution. Further concentration of the reaction mixture yielded white precipitate, which was filtered and dried under vacuum to afford MA as a white solid (0.189 g, 40% (the yield is adjusted to the maximum possible residual NaCl content)). ¹H NMR (400 MHz, D₂O, δ/ppm): 1.90 (s, 3H, CH₃), 1.95 (s, 3H, CH₃), 3.82 (d, ²J_{HP}=12 Hz, 2H, CH₂—P), 3.87 (d, ²J_{HP}=12 Hz, 2H, CH₂—P), 4.32 (s, 2H, CH₂), 4.48 (s, 2H, CH₂), 5.12 (s, 1H, HC═C), 5.29 (s, 1H, HC═C), 5.32 (s, 1H HC═C), 5.41 (s, 1H, HC═C). ¹³C NMR (75 MHz, D₂O, δ/ppm): 19.52 (CH₃), 19.63 (CH₃), 43.44 (d, ¹J_{PC}=147 MHz, —CH₂—P), 47.98 (d, ¹J_{PC}=147 MHz, —CH₂—P), 48.54 (—CH₂—C═O), 51.64 (—CH₂—C═O), 117.63 (CH₂═C—), 118.30 (CH₂═C—), 138.82 (CH₂═C—), 139.28 (CH₂═C—), 172.64 (CH₂—C═O), 173.30, (CH₂—C═O) 175.90, (N—C═O) 176.45 (N—C═O). IR (neat, cm⁻¹): 1720, 1678, 1590, 1462, 1406. HRMS (ES⁺): Calcd. for C₇H₁₃NO₆P [M+H]⁺: 238.0481. Found: 238.0487.

Synthesis of N-Acryloyl-N-(phosphonomethyl)glycine (AA). AA was synthesized using a similar procedure to that described for MA. Acryloyl chloride was used in two-fold excess relative to glyphosate. The reaction was completed in one hour to give M as a white solid in 50% yield (the yield is adjusted to the maximum possible residual NaCl content). ¹H NMR (300 MHz, D₂O, δ/ppm): 3.95 (d, ²J_{HP}=12 Hz, 2H, CH₂—P), 3.98 (d, ²J_{HP}=12 Hz, 2H, CH₂—P), 4.29 (s, 2H, CH₂), 4.50 (s, 2H, CH₂), 5.87 (dd, AMX system, J_{AX}=10.8 Hz, J_{AM}=1.2 Hz, 1H, H₂C═CH), 5.93 (dd, AMX system, J_{AX}=10.8 Hz, J_{AM}=1.2 Hz, 1H, H₂C═CH), 6.25 (dd, AMX system, J_{MX}=16.8 Hz, J_{MA}=1.2 Hz, 1H, H₂C═CH), 6.29 (dd, AMX system, J_{MX}=16.8 Hz, J_{MA}=1.2 Hz, 1H, H₂C═CH), 6.61 (dd, AMX system, J_{XM}32 16.8 Hz, J_{XA}=10.8 Hz, 1H, H₂C═CH), 6.82 (dd, AMX system, J_{XM}=16.8 Hz, J_{XA}=10.8 Hz, 1H, H₂C═CH). ¹³C NMR (75 MHz, D₂O, δ/ppm): 44.24 (d, ¹J_{PC}=150 MHz, —CH₂—P), 46.73 (d, ¹J_{PC}=150 MHz, —CH₂—P), 50.04 (—CH₂—C═O), 50.74 (—CH₂—C═O), 126.86 (CH₂═C—), 126.96 (CH₂═C—), 130.27 (CH₂═C—), 130.65 (CH₂═C—), 169.94 (CH₂—C═O), 169.96 (CH₂—C═O), 172.66 (N—C═O), 172.75 (N—C═O). IR (neat, cm⁻¹): 1722, 1637, 1571, 1472, 1401. HRMS (ES⁺): Calcd. for C₆H₁₁NO₆P [M+H]⁺: 224.0324. Found: 224.0330. Calcd. for C₆H₁₀NO₆PNa [M+Na]⁺: 246.0140. Found: 246.0142.

Determination of Residual Sodium Chloride Content. Residual solid content was estimated by heating a sample at red heat in a crucible for 30 minutes. Crucibles were weighed empty, as well as with the sample both before and after heating. The amount of residual solids was determined for various batches of acrylated product and compared to those of the parent glyphosate. Typical values for the product were 35-45% by weight (versus 5-10% for technical-grade glyphosate). The major solid contaminant was sodium chloride and the product gives a positive silver nitrate test when dissolved in distilled water. The maximum content of NaCl in the product was estimated at 40%.

Computational Methods. The compounds analyzed were N-acryloyl-N-phosphono-methylglycine (AA) and N-methacryloyl-N-phophonomethylglycine (MA). Calculations were performed using Spartan '04 except for B3LYP/6-31++G(d,p)//B3LYP/6-31++G(d,p) calculations which were performed using Gaussian '03 (See Supporting Information). PM3 semi-empirical calculations and density functional methods with diffuse basis sets were used in order to keep the structures from losing their hydrogen-bonded character during optimization.

Structures were selected to maximize hydrogen bonding stabilization. Some structures were chosen in which the phosphoryl group was a hydrogen-bond donor to the acryloyl carbonyl, while the carboxyl group was a hydrogen-bond donor to the negative phosphoryl oxygen. Other structures were chosen with the carboxyl group as a hydrogen-bond donor to the acryloyl carbonyl, while the phosphoryl group was a hydrogen-bond donor to the carboxyl group (Scheme 2).

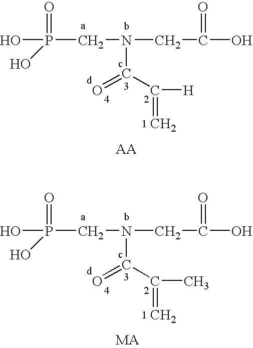

Rotational studies were performed, in which one of two chosen dihedral angles was constrained to a series of values and the rest of the molecule was allowed to relax. Several series of structures were generated by constraining a certain dihedral angle either the acryloyl C═C—C═O dihedral (1-2-3-4) or the amide C(P)—N—C═O dihedral (a-b-c-d) and allowing the rest of the structure to relax by sequential molecular mechanics, PM3 and B3LYP/6-31G calculations. Geometries at and near the local minima identified by the rotational studies were fully optimized (no dihedral angle constraints) at the B3LYP/6-31+G* level.

Eight candidate local minima were found for MA, with vinyl dihedral angles of ±120-130° and ±40-60°. Amide dihedral angles were all within 15° of planarity. Nine candidate local minima were found for AA, with vinyl dihedral angles from −6° to +80; from +127° to +1320; and from −126° to −132°. Candidate local minima were fully optimized at the B3LYP/6-31++G(d,p) level. The absence of imaginary frequencies from vibrational analysis confirmed that all structures found were indeed local minima.

Biological Activity Tests: Materials and Methods

The following materials were tested for biological activity: glyphosate (Monsanto Chemical Co.), acrylated glyphosate (AA), and poly(acrylated glyphosate). Biological activity of methacrylated glyphosate (MA) was not examined in this test. Glyphosate and acrylated glyphosate were dissolved in doubly deionized water (200 mM (the concentration is adjusted for the maximum possible content of the residual NaCl in the acrylated glyphosate)) and these stock solutions were used to prepare all relevant biological media. Polymerization of acrylated glyphosate was also conducted in aqueous media (350 nm irradiation with 1.5% wt. VA-085 initiator), with the same initial concentration of the monomer as for the unconverted AA experiments.

Strains of green algae, cyanobacteria and E. Coli were used as test organisms. The green algae CD 1 Red and cyanobacteria Synechocystos 6803 were obtained from the collection of Prof. George Bullerjahn. Salt water strain of cyanobacteria Synechococcus 7002 was obtained from the collection of Prof. Michael McKay. E Coli DH 5α was obtained from Invitrogen Inc.

Media Preparation and Cell Growth Measurements

Green algae and cyanobacteria were propagated photoautotrophically in 250 mL Erlenmeyer flasks containing 100 mL of liquid BG-11 culture medium (see Supporting Information). The cultures were kept on a rotating shaker (100 rpm) at 25° C. for 4 days and continuously illuminated with cool-white fluorescent light with a constant light intensity of 5000 lux. The grown culture medium was sterilized in an autoclave at 121° C. and 1.05 kg cm⁻² pressure for 20 min. For the cell experiments, 20 mL aliquots of the BG-11 medium containing the green algal ([cells]ᵢₙᵢₜᵢₐₗ=5.9×10⁷ mL⁻¹) or cyanobacteria cells ([cells]ᵢₙᵢₜᵢₐₗ=1.7×10⁹ mL⁻¹) were placed in sterile 50 mL Erlenmeyer flasks. CD 1 Red, Synechocystos 6803 and Synechococcus 7002 were then treated with an aliquot of a stock herbicide solution to bring the final herbicide concentration to 1 mM and incubated for 7 days on a rotator shaker (100 rpm) at 25° C. and continuous light intensity of 5000 lux. Cell counts were correlated with the absorbance and measured as a function of time using a Spectronic 20 Genesis spectrophotometer. As previously reported by Ma et al., 5 the optimal wavelength for monitoring culture growth is 680 nm. Experiments for each herbicide were repeated three times. Control and treated cultures were grown under the same conditions of temperature, photoperiod, and agitation. In each experiment, the inhibition of cell growth in treated cultures was monitored spectrophotometrically and compared to the growth in control samples.

E. Coli was propagated heterotrophically in a 2 mL Eppendorf test-tube containing 1.5 mL of liquid M9 minimum medium (see Supporting Information) and kept on a rotating shaker (100 rpm) at 37° C. for 12 hours. The grown culture medium was sterilized at 121° C., 1.05 kg cm⁻² for 20 min. For the cell experiments, 100 mL aliquots of the M9 medium containing the E. Coli cells ([cells]ᵢₙᵢₜᵢₐₗ=6×10⁵ mL⁻¹) were distributed into sterile 250 mL Erlenmeyer flasks and treated with a stock herbicide solution to obtain a final concentration of 30 mM, followed by an incubation for 24 h on a rotating shaker (100 rpm) at 37° C. Cell counts were correlated with the absorbance at 600 nm over time using a Spectronic 20 Genesis spectrophotometer. Control and treated cultures were grown under the same conditions of temperature and shaking. In each experiment, the inhibition of growth in treated cultures was monitored spectrophotometrically and compared to the growth in control samples.

Agar Experiments

BG-11 medium containing 1.5 wt. % agar was prepared and sterilized at 121° C., 1.05 kg cm⁻² for 20 minutes. Each herbicide tested was prepared as a 30 mM solution and added to the autoclaved agar medium to yield a 1 mM final concentration of the herbicide. A 20 mL aliquot of the liquid agar was transferred into a standard Petri dish (100×15 mm) and allowed to harden at room temperature. Cell suspensions of green algae CD 1 Red, cyanobacteria Synechocystos 6803 and Synechococcus 7002 were inoculated using a sterile inoculation loop. Dishes were stored at 25° C. under illumination with the cool-white fluorescent light having a constant light intensity of 5000 lx. The experiment for each herbicide was repeated five times. Control and treated cultures grew under the same conditions of temperature and photoperiod. In each experiment, the inhibition of growth in treated cultures was monitored relative to the growth in control samples using qualitative visual observation.

Additional experiments for testing the toxicity of the homopolymer of AA were implemented. Ten mL of aqueous polymer solution was placed on a sterile Petri dish and left at room temperature until all water was evaporated (3 days) to form a thin polymer film. Twenty mL of the liquid agar was transferred into the Petri dish and allowed to harden at room temperature. Cell suspensions of green algae CD 1 Red, cyanobacteria Synechocystos 6803 and Synechococcus 7002 were inoculated using a sterile inoculation loop. An analogous system containing no polymer film was used as a control for the experiment. Inhibition of growth in treated cultures was monitored relative to the growth in control samples using qualitative visual observations.

E. Coli Agar Experiments

A M9 minimum medium containing 1.5 wt. % agar was prepared and sterilized at 121° C., 1.05 kg cm⁻² for 20 min. An aliquot of each tested herbicide solution was added to portions of the autoclaved agar to give a 1 mM final concentration of the herbicide. Twenty mL of the liquid agar was poured into a standard Petri dish and allowed to harden at room temperature. E. Coli cell suspensions were inoculated using a sterile inoculation loop and stored at 37° C. for 24 hours. Control and treated cultures were grown under the same conditions. In each experiment, the inhibition of growth in treated cultures was monitored relative to growth in control samples by manually counting the number of colonies.

Kirby-Bauer Experiments

The herbicidal activity of novel acrylated glyphosate and poly(acrylated glyphosate) as well as acrylamide and glyphosate (as controls) was also compared using the Kirby-Bauer disc diffusion method.⁶ Filter paper circles (d=5 mm) soaked with acrylated glyphosate, poly(acrylated glyphosate), glyphosate, and acrylamide solutions of given concentrations were placed on the Petri plates, loaded with a layer of BG-11 containing agar medium (1.5% wt., 10 ml) and a layer of BG-11 containing low melting agarose medium (0.8% wt., 5 ml) previously seeded with green algae CD 1 red (5.9×10⁶ cell/ml, 2 ml) or cyanobacteria Synechococcus 7002 (1.7×10⁸ cell/ml, 2 ml). After phototrophical propagation during the 5 days under cool fluorescence light (intensity 5000 lux), the average radii of inhibition zones were measured. Water soaked filter paper circles were used as controls. Experiments for each herbicide concentration were repeated 3 times.

Results and Discussion

Synthetic Considerations

Two major challenges that arise in the synthesis of glyphosate derivatives are its poor solubility in organic solvents and the presence of both acidic and basic functional groups in the same molecule. Glyphosate exists as a zwitterion.⁷ The acid dissociation constants for glyphosate are pKa₁ 0.8 (first phosphonic), pKa₂ 2.3 (carboxylic), pKa₃ 6.0 (second phosphonic), and pKa₄ 11 (amine). Further, the carboxyl and phosphonyl groups are electrophilic, while the amino group is nucleophilic, while the double-bonded and deprotonated oxygens of the phosphonyl group stabilized by delocalization, resulting in the phosphonyl group being less susceptible to a nucleophilic attack than the carboxyl group.

Attempts to utilize standard esterification routes were unsuccessful. N-(Phosphonomethyl)glycine was converted to the corresponding acyl chloride by reaction with thionyl chloride.⁸ When followed by treatment with the hydroxyethylmethacrylate, a complex mixture, the NMR spectrum of which showed no olefinic signals, resulted. So the reaction products were not separated. Reaction of glyphosate with methacryloyl chloride also failed to yield the corresponding anhydride.

The successful procedure involved activating the glycine carboxylic acid functionality with chlorotrimethylsilane forming the corresponding silyl ester. This glycine derivative then reacts with alcohols to generate the desired glyphosate esters that were isolated by treating the reaction mixture with propylene oxide.⁹ Using this procedure one may obtain the allyl ester of glyphosate in quantitative yield. Nevertheless, all other efforts to prepare the more readily photopolymerizable anhydrides or esters, such as those of methacrylic or acrylic acid, were unsuccessful.

Preparation of the Methacrylate Amide of Glyphosate was Achieved as Follows: N-(phosphonomethyl)glycine was dissolved in an excess of 10% NaOH solution and subsequently treated with the corresponding acyl chloride to form the amide derivative. The challenge was separation of the water soluble glyphosate derivatives from the side product, NaCl. Because the reaction generated a substantial amount of NaCl (the reaction was carried out in six-fold excess of NaOH) and this had to be removed, it was found that it could be managed using the differential solubility of methacrylated or acrylated glyphosate derivatives and that of NaCl in water at different pH. After reaction was completed, the pH of the mixture was adjusted to below zero by adding concentrated hydrochloric acid. At pH=0, the solubility of NaCl is substantially lower than that of the target product and the precipitated alkali metal salt was removed by filtration. The pH of the aqueous solution was then adjusted to 1-2 by adding NaOH⁻ solution. Concentration of the reaction mixture under vacuum led to the precipitation of the desired amide, which was substantially more pure. Similar observations have been made for the solubility of glyphosate and a method for its isolation from aqueous alkali metal solutions has been previously proposed.¹⁰ Despite our extensive efforts to reduce the NaCl content in the final product, the residual NaCl amount remains about 30-40% level.

NMR Spectroscopy

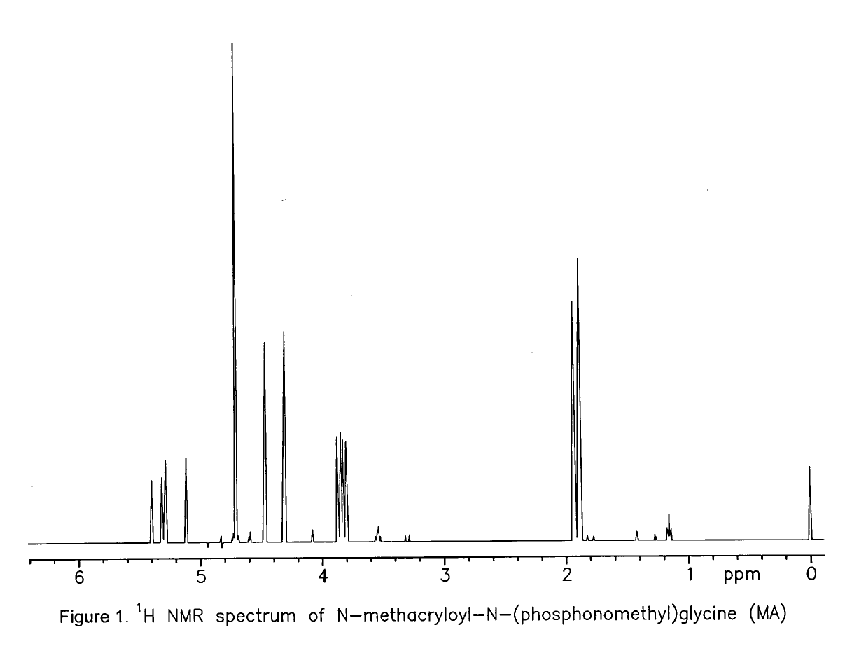

The NMR spectrum of the methacrylic acid derivative of glyphosate is shown in FIG. 1. The ¹H NMR spectrum of N-methacryloyl-N-(phosphonomethyl)glycine (MA) in deuterium oxide shows two identical sets of signals in a 1:1 ratio for all protons; two signals for the methyl group, two doublets for a methylene group attached to phosphorus, two singlets for a methylene group attached to the carboxylic group, and signals for two different double bonds. A similar situation is observed in ¹³C NMR spectra, where all signals are doubled. These complex spectra can be rationalized by the presence of two equally stable isomers of N-methacryloyl-N-phosphonomethyl)glycine.

Amides are known to exist in two conformations owing to hindered rotation around the C—N bond which possesses partial double bond character.^{11,12} The existence of two isomers of N-methacryloyl-N-(phosphonomethyl)glycine in deuterium oxide solution can also be explained by hindered rotation around the C—N bond. Additional stabilization of N-methacryloyl-N-(phosphonomethyl)glycine isomers compared to dimethylformamide arises from the possibility of formation of two strong intramolecular hydrogen bonds (HB). One HB is formed between the methacryloyl oxygen and either carboxylic or phosphonic hydrogen atoms while the second HB interaction occurs between the carboxylic C═O and the second OH group of the phosphonyl moiety. As revealed from the NMR spectra, both conformers are equally populated and, therefore, have similar stability.

It is interesting to note, that the chemical shifts of the methacryloyl double bond signals appear at unusually high field (5.0-5.3 ppm). Typically, signals for this type of protons appear at about 5.5-6.0 ppm downfield of TMS. This may be explained by the conformational preferences of N-methacryloyl-N-(phosphonomethyl) glycine that are governed by steric factors (vide infra).

Similarly to its methacrylated analog, N-acryloyl-N-(phosphonomethyl)glycine (AA) also exists as a mixture of two slowly exchanging conformers at room temperature. Both ¹H and ¹³C NMR spectra of the acryloyl derivative contain two sets of signals for all protons or carbons, respectively. Apparently, the relative stability of two AA conformers is not the same as for MA and the ratio between them is about 1:2. The signals from the AA double bond hydrogen in the ¹H NMR spectrum appear at substantially lower field compared to those of N-methacryloyl-N-(phosphonomethyl)glycine. In general, the electron donating effect of a methyl group is expected to cause an upfield shift. For instance, the signals from the double bond terminal protons of methyl acrylate appear at 6.40 and 5.82 ppm¹³ while the parent signals for methyl methacrylate are at 6.09 and 5.55 ppm. This represents a 0.3 ppm difference in chemical shifts. For methacrylic and acrylic acids this difference is about 0.26 ppm. However, for methacrylic (MA) and acrylic (AA) acid derivatives of glyphosate this difference is nearly 1.5 ppm. This large difference is unlikely to be entirely due to the electron donating abilities of the methyl group and can also be attributed to steric hindrance leading to conformational differences (vide infra).

Conformational Studies at Elevated Temperature

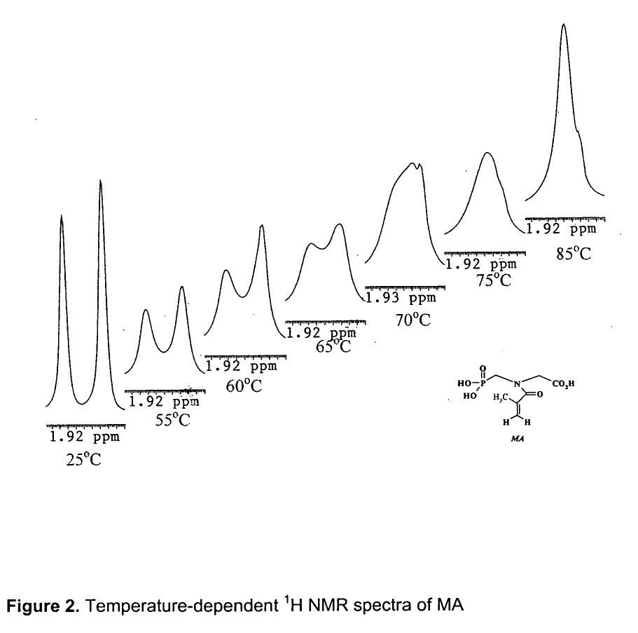

To further elucidate the conformational equilibria of MA and AA, the ¹H NMR signals of interest were observed at elevated temperatures. At room temperature, the ¹H NMR spectrum of MA shows two signals from the methyl groups at 1.90 and 1.95 ppm. Increasing the temperature causes a broadening of those signals which completely merge at 75° C. (FIG. 2). Broadening for all other signals in the NMR spectra was observed, although coalescence occurred only for methyl and methylene (CH₂—P) signals at temperatures up to 85° C. The coalescence temperature for the methyl signals allows one to evaluate the barrier for conformer interconversion. The rate constant for a C—N bond rotation at the temperature of coalescence can be calculated according to the following expression¹⁴:

k=2π(v₁-v₂)/\sqrt{2}

where v₁ and v₂ are the chemical shifts in Hz at the slow exchange limit.

Fitting the rate constant k in the Eyring equation gives the free energy of activation (ΔG^{≠}). Thus, for MA, it was found that the activation energy for conformational isomerism at 348 K was 17.3 kcal/mol.

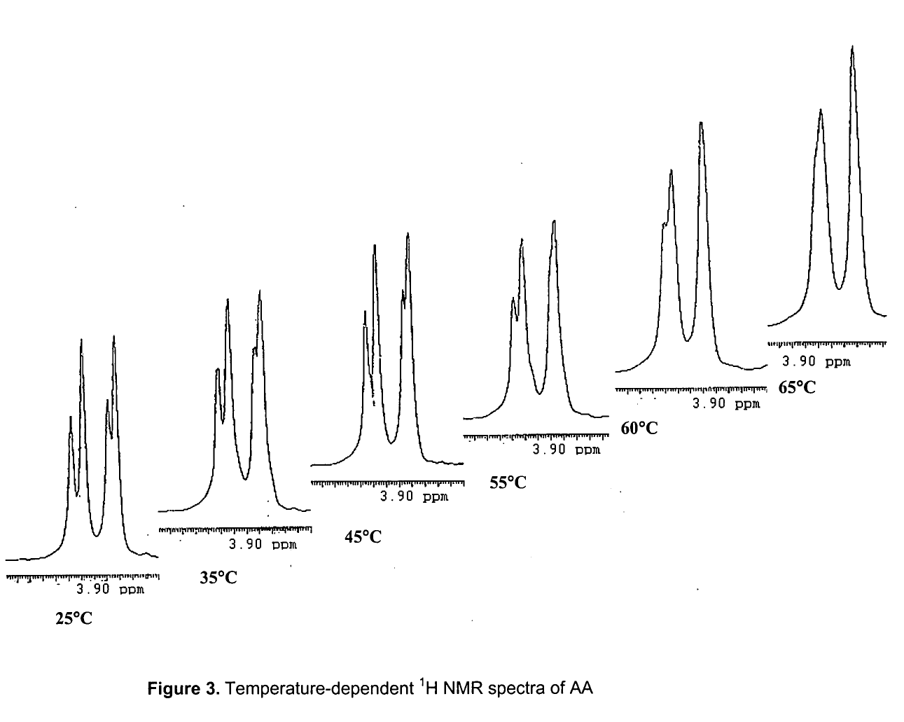

Evaluation of the barrier to internal rotation for AA was more difficult because one had to follow the temperature-dependent changes in more complex signals. The room temperature ¹H NMR of AA shows two doublets centered at 3.95 and 3.98 ppm assigned to the protons of the methylene group attached to phosphorous atom. The signals corresponding to each of the conformers can be easily distinguished from the ²J_{HP}=12 Hz and the difference in their intensity. FIG. 3 follows the changes in the methylene signals obtained from the temperature-dependent ¹H NMR spectra of AA. At elevated temperatures, the signals of the two doublets broaden, come closer to one another, and at 65° C., they overlap to form one doublet (²J_{HP}=12 Hz). The coalescence temperature allowed for the estimation of the free energy of activation for C—N bond rotation of AA (ΔG^{≠}_{338K}=17.9 kcal/mol). A similar value for the activation energy was found for MA conformational interconversion when following the methylene (CH₂—P) signals (ΔG^{≠}_{358K}=17.8 kcal/mol).

Photopolymerization Experiments

¹H NMR spectroscopy was used to follow the photopolymerization of methacrylic and acrylic acid derivatives of glyphosate, MA and AA. These compounds are soluble in water but are poorly soluble in most organic solvents. The polymerization experiments were carried out in deuterium oxide, using radical polymerization initiators. Marginally water-soluble initiators were introduced as an aliquot of a concentrated acetonitrile solution. The samples were then irradiated at 350 nm.

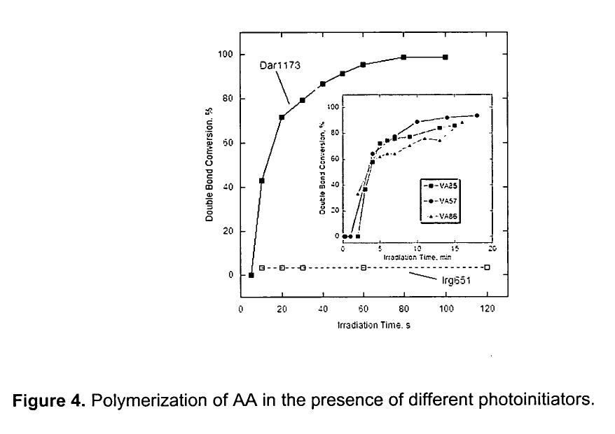

Surprisingly, MA did not polymerize under these conditions although several Norrish Type 1 and diazo-initiators and long irradiation times were used. On the other hand, the acrylic analog AA polymerized efficiently. FIG. 4 shows the conversion of AA double bond using 1.5 wt % Darocur 1173 as the initiator. Over 95% conversion of double bond was achieved in less than 80 sec. The polymerization profile shows a typical autoacceleration effect, leading to an increase of the initial polymerization rate, followed by an autodeceleration effect.

The photopolymerization behavior of AA using Irgacure 651 (FIG. 4), which has a 6-times higher molar extinction coefficient at 350 nm than Darocur 1173, showed an insignificant AA double bond conversion even after 7 minutes irradiation. This is likely because of poor solubility of Irgacure 651 in water.

In an attempt to overcome these solubility issues, photopolymerization rates with several water-soluble diazo initiators were also investigated. The inset of FIG. 4 shows that the polymerization profile of AA obtained using VA-057, VA-85, and VA-86 diazo initiators is slow, but viable and the polymerization behavior of AA is similar in all three experiments. Double bond conversion of 80-90% is achieved after 15 minutes of irradiation. The polymerization time is considerably longer than in the case of Darocur 1173. Although diazo initiators are more soluble in water, their absorption cross sections at 350 nm is half that of the Darocur 1173 and they are also less efficient photoinitiators because carbon radicals produced are not as reactive.

Owing to high polarity of AA monomer, size exclusion chromatography (SEC) was used to determine the molecular weight of the resulting photopolymer. The SEC experiments yielded molecular weight of 55±10 kDa.

The different photopolymerization behavior of methacrylic (MA) and acrylic (AA) acid derivatives can be explained by the different conformational preferences of the two compounds. Generally, methacrylic acid derivatives, although they polymerize more slowly than their acrylic acid counterparts, still often undergo efficient polymerization with a high degree of a double bond conversion. As discussed above, the signals from the double bond protons in the ¹H NMR spectrum of MA appear at unusually high field. Similarly, the double bond signals for N,N-dimethylmethacrylamide appear at 5.3 and 5.03 ppm.¹³ Although not limited to the theory of the invention, the steric bulk of the methyl group may force the MA molecule to adopt a conformation wherein the methacrylic C═O and C═C moieties are not coplanar. This may prevent conjugation of the carbonyl group with the double bond, leading to deactivation of the double bond and its inability to undergo efficient polymerization under free radical polymerization conditions. Other N,N-disubstituted methacrylamides have also failed to polymerize under similar conditions.¹⁵

Computational Results

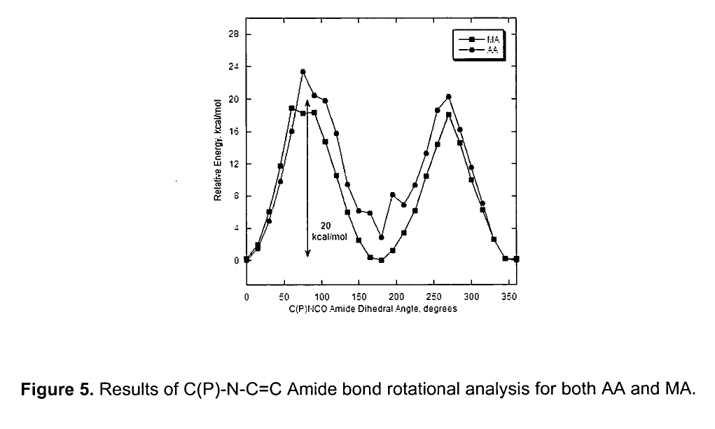

The conformational preferences in both AA and MA were further probed by the calculations. Only one series was evaluated for rotation of the amide C—N bond for both AA and MA, since whether the methacryloyl or acryloyl carbonyl can accept hydrogen bonds from the phosphoryl or the carboxyl group will depend on the value of the dihedral angle (FIG. 5). Two global minima were identified for dihedral angles of ca. 0° (P—OH . . . O═C HB) and ca. 180° (COOH . . . O═C HB), with the dihedral angle defined as C(P)—N—C═O (a-b-c-d) (Scheme 2). High level geometry optimization for two isomers favors the 0° isomer by 2.2 and 3.7 kcal/mol for MA and M, respectively. The observed larger difference in stability of AA conformers is consistent with the experimentally observed difference in the NMR signal ratios for MA (1:1) and AA (2:1).

Our calculations show that the values of the barrier for rotation around C—N bond of MA and AA are quite similar. This suggests that rotation around the C—N bond in MA is not hindered by the methyl group. For both MA and AA, the calculated value for the rotational barrier is around 20 kcal/mole (FIG. 5). This number is in good agreement with the experimental barrier of 17-18 kcal/mole determined from the elevated temperature NMR experiments.

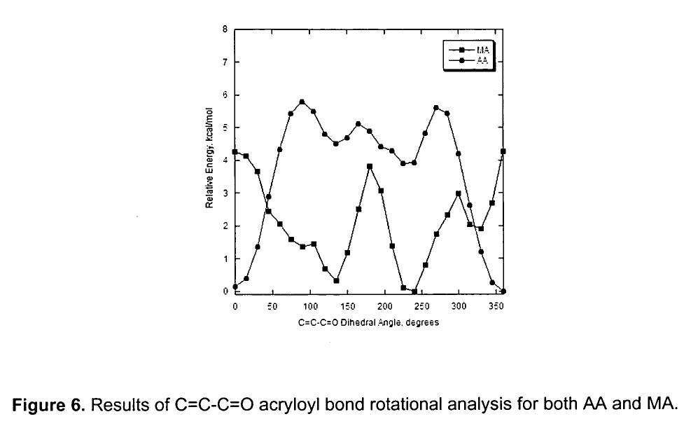

Two structural series were generated by rotating the vinyl group of the methacryloyl moiety, with hydrogen-bond donation to the methacryloyl carbonyl from either the phosphoryl group or the carboxyl group. Possible local minima were identified at ca. 135° and ca. 240° for both series, with the dihedral angle defined as C═C—C═O (1-2-3-4) (Scheme 2). All identified local minima had methacryloyl dihedral angles (1-2-3-4) of roughly ±120° (FIG. 6). The two lowest-energy minima found had calculated energies within 200 cal of each other and methacryloyl dihedral angles of −123° and +121°.

Structural series' were also generated by rotating the vinyl group of the acryloyl moiety of M, with hydrogen-bond donation to the acryloyl carbonyl from either the phosphoryl group or the carboxyl group. Possible local minima were identified at ca. 0°, ca. 135° and ca. 240° for both series, with the dihedral angle defined as C═C—C═O (1-2-34) (Scheme 2). Another possible local minimum was identified at 600 for the series in which the carboxyl group served as the hydrogen-bond donor to the acryloyl carbonyl.

Identified AA local minima showed a wider range of both energy and dihedral angle. As with MA, the “global” minimum had the phosphoryl group acting as a hydrogen-bond donor to the acryloyl carbonyl oxygen. However, optimized dihedral angles fell into two groups: ±2° (the lowest-energy structures) and ±130°. Structures in which the acryloyl group was twisted ±130° lay about 3.5 kcal/mol above the “global” minimum (FIG. 6).

These calculations confirm that the lowest energy conformations of the acryloyl and methacryloyl groups (in AA and MA respectively) differ in the coplanarity of the vinyl and carbonyl moieties as measured by the dihedral angle C(1)=C(2)-C(3)=O(4) [φ]. In AA, the vinyl and carbonyl groups are essentially coplanar (φ=0°) while in MA they are non-coplanar (φ=120°) (FIG. 6). This non-planarity of the acrylic moiety in MA deactivates the double bond which is consistent with the experimentally observed lack of polymerization for methacrylated glyphosate.

Biological Activity of AA and its Polymer

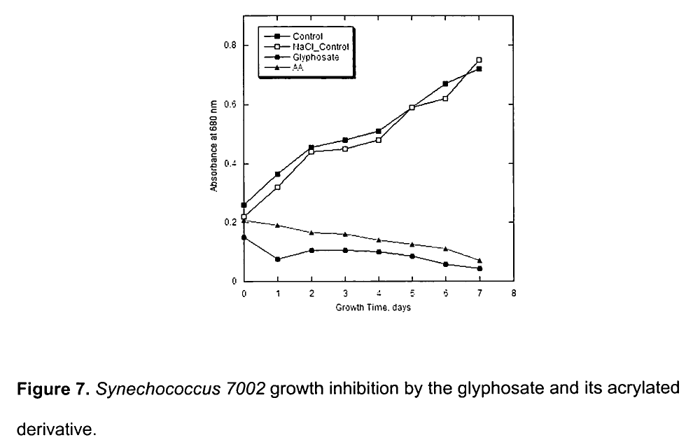

Results of the biological activity trials are summarized in Table 1. The difference in growth response of Synechococcus 7002 after treatment with herbicides is shown graphically in FIG. 7. Both glyphosate and acrylated glyphosate display approximately equal inhibition of growth in both strains of cyanobacteria and CD 1 Red (Table 1) These data clearly demonstrate that the newly synthesized polymerizable acrylated glyphosate derivative possesses herbicidal activity similar to that of the unfunctionalized glyphosate. The residual salt present in the glyphosate sample had no effect on the media growth as was demonstrated by NaCl control experiments for Synechococcus 7002 (FIG. 7).

TABLE 1
Results of the Biological Activity Screening

| | | Optical Density at 680 nm after 7 days of media growth | | |
|---|---|---|---|---|
| Organism | Description | Control | Glyphosate | Acrylic Glyphosate (AA) |
| CD1 Red | Green Algae^{a} | 0.55 | 0.02 | 0.02 |
| Synechocystos | Cyanobacteria | 1.4 | 0.58 | 0.54 |
| 6803 | (fresh water | | | |
| | strain)^{b} | | | |
| Synechococcus | Cyanobacteria | 0.72 | 0.04 | 0.07 |
| 7002 | (salt water strain)^{b} | (0.75 NaCl) | | |
| E. Coli | Bacteria^{b} | 1.30^{c} | 1.20^{c} | 1.24^{c} |

A. ^{a}eukaryotic organism
B. ^{b}prokaryotic organism
C. ^{c}Owing to a faster growth of E. Coli, measurements were taken after 24 hours of growth.

Inhibition of the growth of E. Coli was observed only during the first 10 hours of incubation. Beyond 24 hours of media growth, the optical density of the treated samples matched that of the controls. Therefore, both glyphosate and its acrylated derivative do not display reasonable toxicity towards E. Coli. However, the agar experiments show significant difference between the number of E. Coli colonies in treated samples (11—glyphosate and 6—AA) and controls (36 colonies).

Synechocystos 6803, Synechococcus 7002 and CD 1 Red agar plates treated with glyphosate, acrylated glyphosate and homopolymer of acrylated glyphosate showed complete inhibition of growth and bleaching of the culture compared to the control sample. As an example, the tests were conducted on Petri dish surfaces coated with a polymeric AA film cast from an aqueous solution relative to a control. These results suggest that the homopolymer of AA also possesses herbicidal activity toward cyanobacteria and algae.

The herbicidal activity of novel compounds was further elucidated by additional Kirby-Bauer tests. The capabilities of novel compounds in inhibiting the growth of the tested cyanobacteria and algae on solid media are listed in Table 2.

TABLE 2
Average radii of the inhibition zones measured around the filter paper
circles treated with the designated compound.

| | | Inhibition | Inhibition by | | |
|---|---|---|---|---|---|
| | Herbicide | by | acrylated | Inhibition by | Inhibition |
| | concentration, | glyphosate, | glyphosate, | acrylamide, | by |
| Culture | mM | mm | mm | mm | polymer, mm |
| Syn. | 0.3 | No | No | No | 9 (0.025 g/ml) |
| 7002 | 3 | 6 | No | No | 13.5 (0.25 g/ml) |
| | 30 | 8 | 6.5 | No | |
| | 300 | Complete | 15 | Complete | |
| | | inhibition | | inhibition w/ | |
| | | w/ | | bleaching | |
| | | bleaching | | | |
| CD1 Red | 0.3 | No | No | No | 13 (0.025 g/ml) |
| | 3 | No | No | No | 22 (0.25 g/ml) |
| | 30 | 7.5 | No | No | |
| | 300 | Complete | 10 | 7.5 | |
| | | inhibition | | | |
| | | w/ | | | |
| | | bleaching | | | |

Based on the Kirby-Bauer test results it is concluded that acrylated glyphosate displays herbicidal activity which is lower than the parent glyphosate but higher than control acrylamide. Poly(acrylated glyphosate) also possesses fairly high herbicidal activity against cyanobacteria and algae.

In summary, new polymerizable derivatives of glyphosate were synthesized and results of biological tests confirmed herbicidal activity. This type of biologically active acrylic monomer has a valuable potential for the development of new bioactive coatings with herbicidal properties.

Having demonstrated biological activity for the acrylated derivative of a glyphosate,¹⁰ this glyphosate derivative may acts as a herbicide, such as its presence in a coating may impede biofilm formation by preventing attachment of photosynthetic cyanobacteria and diatoms. This, in turn, is expected may prevent the attachment of larger invertebrates. In addition, an acrylic functionality permits chemical incorporation of the biocide into a coating ensuring better control of release rates. This, in turn, is expected to prolong the service lifetime of the coating.

Experimental Section

Materials

The acrylated derivative of glyphosate (AA) was synthesized according to the procedure described herein. All acrylic monomers and epoxy acrylic oligomers were obtained from either Sartomer or UCB Chemicals and used as received. Photoinitiators Darocure 1173 and Irgacure 819 were obtained from CIBA. Synergist 2-ethylhexyl-4-(dimethylamino)benzoate (ODAB—First Chemical Corporation, 98%) and photoinitiator isopropylthioxanthone (ITX—New Sun Chemical Co. Ltd., 98%) were used as received. Cultures of diatoms Phaeodactylum tricomutum Bohlin and Navicula pelliculosa (Breb. et Kuetzing) Hilse were obtained from The Provasoli-Guillard National Center for Culture of Marine Phytoplankton.

General Procedures

¹H and ¹³C NMR spectra were recorded using Bruker Avance 300 MHz nuclear magnetic resonance spectrometer. Sample irradiations were carried out using either an array of 395 nm LEDs from Clearstone Inc. equipped with CF-1000 power supply or with a Rayonet photochemical reactor equipped with the 350 nm lamps.

Photo-Copolymerization Experiments

Photo-copolymerization was carried out by irradiation of ca. 17% solutions of acrylated glyphosate derivative (AA) and 17% of 2-hydroxyethyl acrylate (HEA) in D₂O in presence of 1.5 wt. % of Darocure 1173 using a RMR-600 Rayonet reactor. Solutions were irradiated in borosilicate glass NMR tubes. The extent of polymerization was monitored by ¹H NMR by observing the disappearance of the signals for vinyl hydrogens of AA and HEA.

Photopolymer Pellet Preparation.

Rectangular copolymer pellets (15×10×1.5 mm) were formed from a model acrylic resin (designated as 459S2) containing several epoxy acrylic oligomers (57%), acrylic monomeric diluents (43%) and a corresponding amount of herbicide. A designated quantity of herbicide was dispersed or partially dissolved in 459S2 resin using ultrasonication and heat (60° C., overnight). To each sample, 1.5% wt. of commercial photoinitiator (ITX), 5% of ODAB synergist and 0.1% co-photoinitiator (Irgacure 819) were added. Liquid formulations were poured into an open top Teflon mold and irradiated under N₂ by a 395 nm LED light source for 5 min followed by pellet removal.

Herbicide Release Experiments

Round copolymer pellets (d=5 mm, h=2 mm) were formed from a 459S2 resin and a proper amount of herbicide. Liquid formulation (1 g) was loaded with 2.4%, 3.2%, and 6% wt. of acrylated glyphosate or 1.6%, 2.4% and 5% wt. of glyphosate. To each sample, 1.5% wt. of Irgacure 819 was added. The formulations were poured into a plastic mold and irradiated at 350 nm (Rayonet) under N₂ for 5 min. The resulting pellets were placed in 1 ml of D₂O and kept on a shaker (100 rpm) for 20 days. The amount of herbicide released was periodically monitored by observing the ¹H NMR of pellets washings. Peak intensities from standard glyphosate and acrylated glyphosate D₂O solutions (containing herbicide amounts identical to the loads in the pellets) were used to normalize the amount of herbicide released.

Biological Activity Experiments

Two different diatom cultures, Phaeodactylum tricornutum and Navicula pelliculosa were used in the biological activity tests. Polymer pellets loaded with different concentrations (0.1, 0.15, and 0.3 M) of glyphosate and acrylated glyphosate were placed on Petri plates loaded with a layer of f/2-containing agar medium (1.5% wt., 10 ml—See Supporting Information) and a layer of f/2-containing low melting agarose medium (0.8% wt., 5 ml) previously seeded with diatoms. Following propagation over 5 days under continuous cool fluorescent light (5000 lx), the average radii of inhibition zones were measured. Experiments for each herbicide concentration were repeated at least two times. Pellets comprised of model resin 459S2 without glyphosate additives were used as controls.

Field Trials: Periphyton Biofouling Assessment in an Artificial Stream Facility

Field tests were conducted during July and August, 2006 at the University of Michigan Biological Station Experimental Stream Laboratory located near Douglas Lake, Pellston, Mich. Resin 459S2 containing 0.15 M of a designated herbicide was coated on terracotta ceramic tiles (3×6 inches) pretreated with silanes for improved adhesion and photocured by an H-bulb system obtained from Fusion Inc. The coating thickness was 12.5 μm (0.5 mil). Bare tiles and tiles coated with 459S2 containing no additive were used as controls. Nine tiles for each series were placed into separate flow channels with a constant water flow of 3 L min⁻¹ for each channel. Each flow channel utilized water pumped from the East Branch of the Maple River containing natural freshwater biofouling organisms. Each flow channel was covered with a mesh screen to reduce direct light exposure and to ensure more favorable growth conditions. Tiles were left in the flow channels for 10 days.

Chlorophyll (chl) biomass attached to the surface of each tile was determined after the tiles had been washed three times with tap water to remove mud and other loosely attached species. The coated surface of the tile was submerged into a plastic vessel containing 25 mL of 90/10 acetone/saturated aqueous MgCl₂. The container itself was placed into an ultrasonic bath and the entire system was sonicated for 30 seconds to facilitate chl extraction. The UV-vis spectrum of each extract was measured on a Shimadzu diode-array spectrophotometer using a 1 cm quartz cell. The amount of chl was determined using the following equation:²⁹

[Chl](μg/tile)=(11.87(A₆₆₃₋₇₅₀)−1.54(A₆₄₅₋₇₅₀)−0.08(A₆₃₀₋₇₅₀))*25 mL)/l

where A_{λ1-λ2} is the difference in absorbance at two designated wavelengths and l is the spectroscopic cell pathlength. Two independent field trials were conducted.

Results and Discussion

Copolymerization Experiments

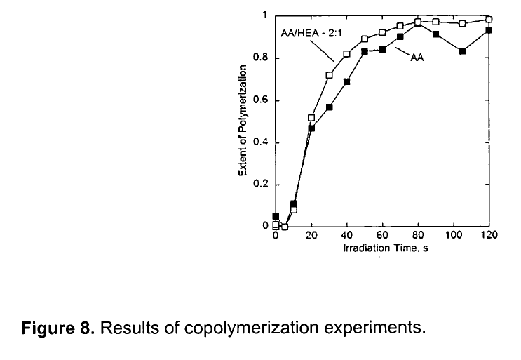

It has been shown that both the monomer and homopolymer of the acrylated glyphosate exhibited biological activity. The next important task was to demonstrate the possibility of copolymerization of AA with other acrylates. For that, AA was copolymerized with 2-hydroxyethyl acrylate (HEA). Upon 350 nm irradiation of a D₂O solution, AA conversion was complete in a short period of time, in accordance with the previous observations.¹⁰ When a mixture of AA and HEA was subjected to a similar irradiation, the monomer conversion observed for copolymerization was as fast as in the case of a solo AA (FIG. 8).

Additional copolymerization experiments were conducted. To the mixtures listed in Table S1, 1.5% w/w of Darocur 1173 photoinitiator was added. The resulting mixtures were spin-coated on glass slides followed by irradiation at 350 nm. All resulting films adhered to the slides. The combination of AA with HEA resulted in tougher and less brittle films. Quantitative measurements of the film properties of these copolymers, however, were not pursued. Each of the results verifies that AA may be successfully copolymerized with other acrylates.

Biological Activity of Model Coatings

To test the biological activity of AA incorporated into the acrylic formulation, the acrylic matrix (less all pigments) was adapted from a commercial anticorrosion marine paint as a model.³⁰ Two diatom strains were used in these experiments because of their known roles as precursors for marine biofouling.³¹ Similar observations were made for both diatom strains tested (Table 3). When the acrylic resin contained no herbicide, inhibition of diatom growth was minimal. Incorporation of similar molar concentrations of non-functionalized glyphosate and acrylated glyphosate into a model resin resulted in either substantial growth inhibition, or complete bleaching in the case of high herbicide concentrations. This was observed for both non-functionalized and functionalized glyphosates despite their different arrangements within the coating. The former was a (poly)acrylic matrix with glyphosate particles trapped in the pores while the latter was a copolymer where acrylated glyphosate was chemically incorporated into the polymer backbone.

TABLE 3
Average radii of the inhibition zones measured around the
polymer pellets containing the designated compound. Data are
presented from triplicate assays on 100 mm agar plates.

| | | | Diameter of Inhi- |
|---|---|---|---|
| | | | bition Zone, mm |
| | Herbicide | Concentration | (Bleaching indicates |
| Strain Name | in Polymer | in Pellet, | no growth detected |
| (Diatom) | Pellet | M (% mass) | on 100 mm plate |
| Navicula | None | 0.0 (0.0) | 10 ± 1 |
| | AA | 0.15 (3.2) | 20 ± 2 |
| | AA | 0.3 (6.0) | Bleaching |
| | Glyphosate | 0.15 (2.4) | 22.5 ± 2 |
| | Glyphosate | 0.3 (5.0) | Bleaching |
| Phaeodactilum | None | 0.0 (0.0) | 0 (no inhibition) |
| | AA | 0.1 (2.4) | 23 ± 2 |
| | AA | 0.3 (6.0) | Bleaching |
| | Glyphosate | 0.1 (1.6) | 17.5 ± 2 |
| | Glyphosate | 0.3 (5.0) | Bleaching |

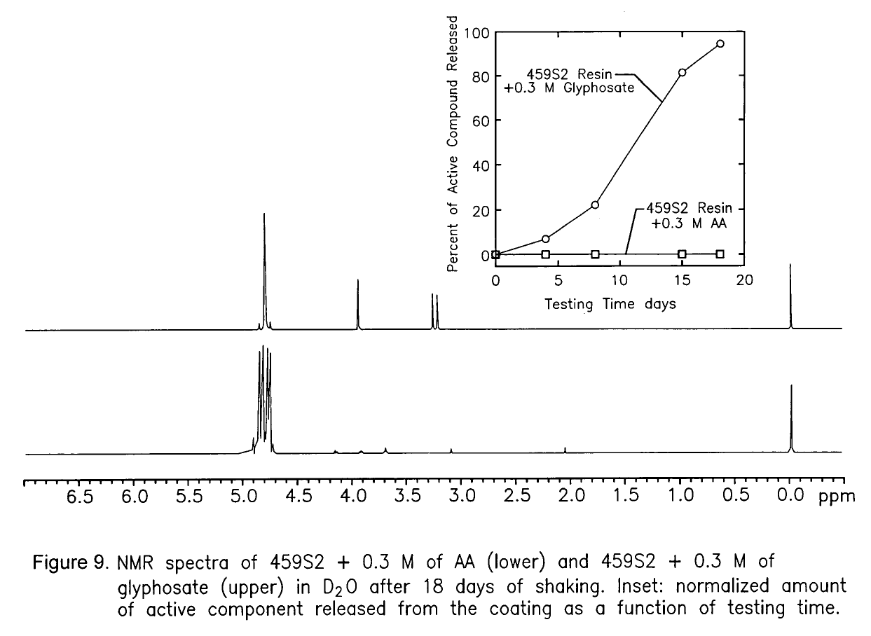

These structural differences were reflected in the rates of release of the active component from the coating (FIG. 9). While about 94% of loaded non-functionalized glyphosate was depleted from the coating after 18 days of shaking in D₂O, no NMR detectable release of AA (or products of AA decomposition) was observed over the same time period. This leads to an important observation: in the case of AA copolymer, the glyphosate functionality is chemically incorporated into a polymer preventing its rapid release. However, the resulting polymer demonstrates significant biological activity. This observation highlights the excellent antifouling potential of AA containing coatings.

Field Trials: Periphyton Biofouling Assessment in an Artificial Stream Facility.

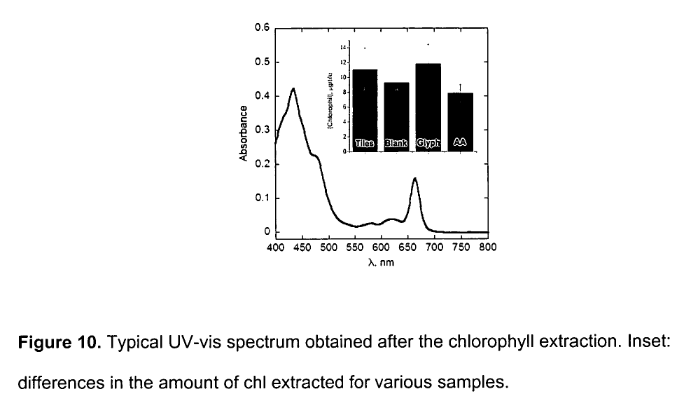

Absorption spectra of acetone-extracted pigments (FIG. 10) show that the dominant pigment present was chl a (peaks seen at 435 nm and 663 nm). Transformation of the data to yield a second derivative spectrum also indicated the presence of absorbing species at 468 nm and 645 nm, suggestive of chl b, and 455 nm and 630 nm, indicative of chl c. These data suggest that the major taxa adhering to the tiles were likely cyanobacteria (containing only chlorophyll a), green algae (containing both chl a and b) and diatoms (containing chls a and c). The presence of diatoms as a major member of the stream facility biota has been described previously.³³

Total chl extracted from bare uncoated tiles established a baseline for attachment with extracted chl of 11.1±2.87 μg tile⁻¹ (FIG. 2, inset). Blank tiles coated with resin containing no herbicide yielded similar periphyton chl biomass (9.35±1.07 μg tile⁻¹) as did tiles containing unfunctionalized glyphosate (11.9±2.56 μg tile-1) (one way analysis of variance, P>0.05, df=17). The lack of inhibition by unfunctionalized glyphosate can be justified using our release data. Glyphosate, when chemically not bound, rapidly leaches out of the coating. Further, this leaching is expected to create porosity on a coated surface promoting attachment of microorganisms.³² Finally, the composition containing AA imbedded into the polymer backbone yielded the least amount of attached biomatter (7.92±1.12 μg tile⁻¹), roughly one-third of the periphyton chl measured from tiles containing unfunctionalized glyphosate (unpaired two-tailed t-test, P<0.05) and thus, supporting the good potential of AA as a biocide.

In summary, new polymerizable derivatives of glyphosate were blended into a polyacrylate formulation and copolymerized. The copolymer resulting retained the herbicidal activity of the monomer as indicated by biological tests. These biologically active acrylic formulations have potential as anti-biofouling coatings.

Other embodiments of the present invention will be apparent to those skilled in the art from consideration of the specification and practice of the invention disclosed herein. It is intended that the specification and examples be considered as exemplary only, with a true scope and spirit of the invention being indicated by the following claims.

### REFERENCES

1. Franz, J. E. U.S. Pat. No. 3,799,758, Mar. 26, 1974.
2. Franz, J. E. U.S. Pat. No. 3,853,530, Dec. 10, 1974.
3. Appleton, T. G.; Byriel, K. A.; Hall, J. R.; Kennard, C. H. L.; Lynch, D. E.; Sinkinson, J. A.; Smith, G Inorg. Chem. 1994, 33, 444-455.
4. Gough, S. T. D. U.S. Pat. No. 4,364,767, Dec. 21, 1982.
5. Ma, J.; Xu, L.; Wang, S. Weed Science 2002, 50, 555-559.
6. Bauer A. W.; Kirby W. M.; Sherris J. C. Am. J. Clin. Pathol. 1966, 45, 493-496.
7. Knuuttila, P.; Knuuttila, H. Acta Chem. Scand. 1979, B33, 623-626.
8. Pontikis, R.; Benhida, R.; Aubertin, A-M.; Grierson, D.; Monneret, C. J. Med. Chem. 1997, 140, 1845-1854.
9. Riebel, H.-J. PCT Int. Appl. WO 97/31534, Sep. 4, 1997.
10. Hideo Miyata, K.; Toru Sasaki, F.; Kohei Morikawa, K. U.S. Pat. No. 5,859,289, Jan. 12, 1999.
11. Eliel, E. L.; Wilen, S. H.; Mander C. N. Stereochemistry of Organic Compounds; John Wiley & Sons, Inc.: New York, 1994, pp. 550-555.
12. Silverstein, R.; Webster F. Spectrometric Identification of Organic Compounds, 6^{th} ed.; John Wiley & Sons, Inc.: New York, 1997, pp. 170-178.
13. Spectral Database System Home Page http://www.aist.go.jp/RIODB/SDBS/cqi-bin/cre index.cgi.
14. Akitt, J. W. NMR and Chemistry. An Introduction to Modern NMR Spectroscopy, 3^{rd} ed.; Chapman and Hall: London, 1992, pp. 135-158.
15. Sokolova, T.; Chetyrkina, G. Vysokomolekulyamye Soedineniya 1961, 3, 244-247.
16. Rittschof, D., Biofouling 2000, 15, 119.
17. (a) Yerba, D. M.; Kill, S.; Dam-Johansen, K. Prog. Org. Coat. 2004, 50, 75-104.; (b) Rascio, V. J. D. Corros. Rev. 2000, 18, 133-154.
18. Marine BioFoulNet http://www.biosciences.bham.ac.uk/external/biofoulnet
19. Callow, M. E., Chem. Industry 1990, 5, 123. (b) Callow, M. E. and Callow, J. E., Biologist 2002, 49, 1-5.
20. (a) Ghiya, S, N. Paintindia 1987, 19-30.; (b) Rascio, V. J. D.; Giudice, C. A.; Del Amo, B. Corros. Rev. 1988, 8, 87-153.
21. (a) Omae, I. Appl. Organometal. Chem. 2003, 17, 81-105.; (b) Kiil, S.; Weinell, C. E.; Pedersen, M. S.; Dam-Jaohansen, K.; Codolar, S. A. J. Coat. Technol. 2002, 74, 45-54.; (c) International Marine Coatings home page: http://www.international-marine.com.
22. (a) Brady, R. F. Prog. Org. Coat. 2001, 43, 188-192.; (b) Thunemann, A. F.; Kublickas, R. H. J. Mater. Chem. 2001, 11, 381-384.
23. (a) Ryle, M. The Motor Ship 1999, 34.; (b) Anderson, C. D. IBC UK, IBC UK Conferences Limited, United Kingdom, 1998, pp. 1-12.
24. (a) Champ, M. A. Sci. Total Environ. 2000, 258, 21-71.; (b) Champ, M. A. Proceedings of the 24^{th} UJNR (US/Japan) Marine Facilities Meeting, Hawaii, Nov. 7-8, 2001.
25. Bogdanova, A, Piunova, V., Berger, D., Fedorov, A. V., Neckers, D.C. Biomacromolecules, 2006, in press.
26. Bentley, R. Biochemistry and Molecular Biology 1990, 25, 307
27. Levin, J. G.; Sprinson, D. B. Journal of Biological Chemistry 1964, 239, 1142.
28. Ternan, N. G., McGrath, J. W., McMullan, G., Quinn, J. P. World Journal of Microbiology and Biotechnology 1998, 14, 635-647.
29. ESS Method 150.1, Environmental Science Section, Wisconsin State Lab of Hygiene, webpage: http://www.epa.gov/glnpo/lmmb/methods/methd 150. pdf.
30. Mejiritski, A., Marino, T.; Martin, D.; Berger, D. J.; Fedorov, A. V.; Anyaogu, K. C.; Ermoshkin, A. A.; Neckers, D.C. RadTech Reports, 2006, July/August, 11-20.
31. (a) Sitaraman, K.; Wang, N.; Ober, C. K.; Finlay, J. A.; Callow, M. E.; Callow, J. A.; Hexemer, A.; Sohn, K. E.; Kramer, E. J.; Fischer, D. A. Biomacromolecules 2006, 7, 1449.; (b) Finlay, J. A.; Callow, M.; Ista, L.; Lopez, G. P.; Callow J. A. Integr. Comp. Biol. 2002, 42, 1116.; (c) Callow, M. E. In Biofilm: Recent Advances in Their Study and Control; Evans, L. V., Editor; Harwood Academic Publishers: Amsterdam, 2000; p. 189.
32. (a) Callow, M. E.; Jennings, A. R.; Brennan, A. B.; Seegert, C. E.; Gibson, A.; Wilson, L.; Feinberg, L. A.; Baney, R.; Callow, J. A. Biofouling, 18, 2002, 237.; (b) Hoipkemer-Wilson, L.; Schumaker, J. F.; Carman, M. L.; Gibson, A. L.; Feinberg, L. A.; Callow, M. E.; Finlay, J. A.; Callow, J. A.; Brennan, A. B.; Biofouling, 20, 2004, 53.
33. (a) Stelzer, R. S., Lamberti, G. A. Limnology and Oceanography, 2001, 46, 356-367; (b) Stelzer, R. S., Lamberti, G. A. Ecology, 2002, 83, 1039-1051.

All of the foregoing references are incorporated herein by reference.

What is claimed is:

1. A composition comprising an acrylamide derivative of glyphosate (AA).

2. A composition comprising a methacrylamide derivative of glyphosate (MA).

3. A polymeric composition comprising a monomeric unit derived from an acrylamide derivative of glyphosate.

4. A polymeric composition according to claim 3 wherein said polymeric composition is a homopolymer.

5. A polymeric composition according to claim 3 wherein said polymeric composition is a co-polymer.

6. A polymeric composition according to claim 3 wherein said polymeric composition is a co-polymer formed from monomeric units of at least one other acrylic compound.

7. A method of making an acrylamide derivative of glyphosate comprising the step of reacting glyphosate with at least one acryloyl halide for sufficient time to allow for the formation of an acrylamide derivative of glyphosate.

8. A method of making a methacrylamide derivative of glyphosate comprising the step of reacting glyphosate with at least one methacryloyl halide for sufficient time to allow for the formation of an methacrylamide derivative of glyphosate.

9. A method of coating a substrate with a polymeric coating, said method comprising the steps:
(a) placing on said substrate a coating precursor comprising an acrylamide derivative of glyphosate; and
(b) polymerizing said acrylamide derivative of glyphosate so as to form a polymeric coating upon said substrate.

10. A molecule having a formula selected from the group consisting of:

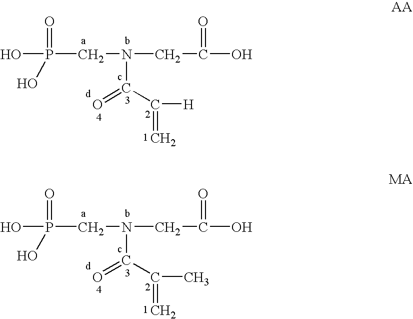

11. A homopolymer having a monomeric unit derived from a compound having the formula:

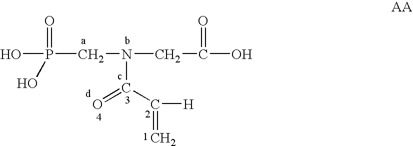

12. A copolymer having a monomeric unit derived from a compound having the formula:

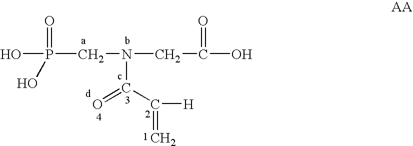

13. A method of removing or reducing plant life in a terrestrial environment comprising placing in contact with said plant life a polymeric coating of a polymer having a monomeric unit derived from a compound having the formula:

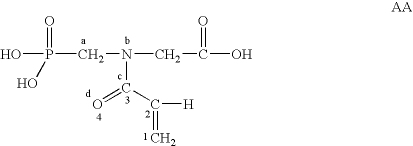

14. A method of removing or reducing plant life in an aquatic environment comprising placing in said aquatic environment a polymeric coating of a polymer having a monomeric unit derived from a compound having the formula:

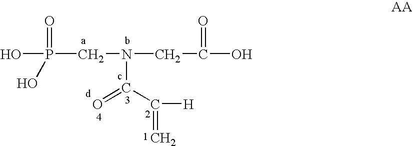

15. A method of preventing biofouling of an article in an aquatic environment comprising placing upon said article a polymeric coating of a polymer having a monomeric unit derived from a compound having the formula: [chemical structure]
